(19) United States
(12) Patent Application Publication
(10) Pub. No.: US 2025/0284308 A1
(43) Pub. Date: Sep. 11, 2025

(54) Clock frequency regulating circuit

(71) Applicant: REALTEK SEMICONDUCTOR CORPORATION, Hsinchu (TW)

(72) Inventors: YUNG-MING LIN, Hsinchu (TW); Ming-Siao Shih, Hsinchu (TW); Jing-Chu Chan, Hsinchu (TW); Bing-Juo Chuang, Hsinchu (TW)

(21) Appl. No.: 19/063,397

(22) Filed: Feb. 26, 2025

(30) Foreign Application Priority Data
Mar. 5, 2024 (TW) 113107993

(51) Int. Cl. G06F 1/08

(52) U.S. Cl. CPC G06F 1/08

(57) ABSTRACT

A clock frequency regulating circuit includes a memory circuit, a frequency detection circuit, and a clock management unit (CMU). The memory circuit is configured to store data according to an input clock, and to output the data according to an output clock. The frequency detection circuit is coupled with the memory circuit, and configured to detect the variation in a used amount of a storage space of the memory circuit and accordingly generate a frequency detection result. The CMU is coupled with the frequency detection circuit, and configured to regulate the frequency of the output clock according to the frequency detection result.

### BACKGROUND OF THE INVENTION

### 1. Field of the Invention

The present disclosure relates to a clock frequency regulating circuit, especially to a clock frequency regulating circuit capable of adaptively regulating the frequency of an output clock of a memory circuit according to the variation in the used amount of a storage space of the memory circuit.

### 2. Description of Related Art

A signal will attenuate after long distance transmission, and a retimer can receive the attenuated signal and recover it. The retimer is a mixed-signal analog/digital device having a protocol-aware capability and being able to extract a clock of a received signal; accordingly, the retimer can recover data of the received signal according to the extracted clock and use a clean version of the extracted clock to transmit a fresh copy of the data. In brief, the retimer can completely recover data of a received signal and transmit a fresh copy of the data.

Generally, a conventional retimer must align a transmission clock (i.e., an output clock) with a reception clock (i.e., an input clock) to realize frequency synchronization and thereby reduce the size of a buffer, that is used for compensating for the reception/transmission clock frequency deviation, and consequently miniaturize the area of the whole circuit.

However, in the process of aligning the transmission clock, if the difference between the frequency of the transmission clock and the frequency of the reception clock is significant, a large amount of frequency variation in the transmission clock will occur at the moment of adjusting the transmission clock, and this will prevent a back-end reception device from correctly receiving the data outputted by the retimer. In addition, aligning the transmission clock with the reception clock will cause the output signal of the retimer to carry a frequency fluctuation of the input signal of the retimer, which will degrade the quality of the output signal.

### SUMMARY OF THE INVENTION

An objective of the present disclosure is to disclose a clock frequency regulating circuit applicable to a retimer and capable of preventing the problems of the prior art.

An embodiment of the present disclosure of the clock frequency regulating circuit includes a memory circuit, a frequency detection circuit, and a clock management unit (CMU). The memory circuit is configured to store data according to an input clock and output the data according to an output clock. The frequency detection circuit is coupled with the memory circuit, and is configured to detect a variation in a used amount of a storage space of the memory circuit and accordingly generate a frequency detection result. The CMU is coupled with the frequency detection circuit, and is configured to regulate a frequency of the output clock according to the frequency detection result. In an exemplary implementation of the embodiment, the frequency detection circuit determines which of a plurality of variation intervals the variation in the used amount of the storage space of the memory circuit falls within; when the variation falls within a first variation interval of the plurality of variation intervals, the frequency detection circuit generates the frequency detection result to request the CMU to regulate the frequency of the output clock according to a first degree of adjustment; and when the variation falls within a second variation interval of the plurality of variation intervals, the frequency detection circuit generates the frequency detection result to request the CMU to regulate the frequency of the output clock according to a second degree of adjustment.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of the clock frequency regulating circuit of the present disclosure.

FIG. 2 shows the variation in the deviation of the frequency of the input clock of FIG. 1, the adjustment in the frequency of the output clock of FIG. 1, and the variation in the water level of the memory circuit of FIG. 1.

### DETAILED DESCRIPTION OF THE PREFERRED EMBODIMENTS

The present specification discloses a clock frequency regulating circuit applicable to a retimer and capable of adaptively regulating the frequency of an output clock of a memory circuit according to the variation in the used amount of a storage space of the memory circuit.

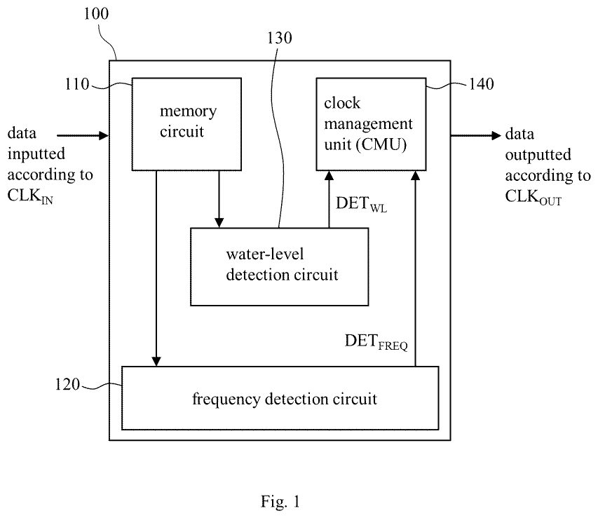

FIG. 1 shows an embodiment of the clock frequency regulating circuit of the present disclosure. As shown in FIG. 1, the clock frequency regulating circuit 100 includes a memory circuit 110, a frequency detection circuit 120, a water-level detection circuit 130, and a clock management unit (CMU) 140.

Referring to FIG. 1, the memory circuit 110 is a circuit having a storage function such as a static random-access memory (SRAM), a first-in-first-out buffer (FIFO), or a counter. The memory circuit 110 is configured to store data according to an input clock CLK_{IN} and output the data according to an output clock CLK_{OUT}. The frequency detection circuit 120 is coupled with the memory circuit 110 and the CMU 140, and is configured to detect the variation in the storage space (not shown in FIG. 1) of the memory circuit 110 (e.g., the variation in the used amount of the storage space in a predetermined period of time) and thereby generate a frequency detection result DET_{FREQ} for the CMU 140. The water-level detection circuit 130 is coupled with the memory circuit 110 and the CMU 140, and is configured to detect the used amount of the storage space (hereinafter referred to as “water level”) of the memory circuit 110 and thereby generate a water-level detection result DET_{WL}. The CMU 140 is coupled with the frequency detection circuit 120 and the water-level detection circuit 130, and is configured to regulate the frequency of the output clock CLK_{OUT} according to the frequency detection result DET_{FREQ} and optionally according to the water-level detection result DET_{WL}. It is noted that the term “water level” in this specification can be understood as the remaining amount of the storage space. It is also noted that the water-level detection circuit 130 can be disabled or omitted from the present embodiment if the performance of the clock frequency regulating circuit 100 is negligible.

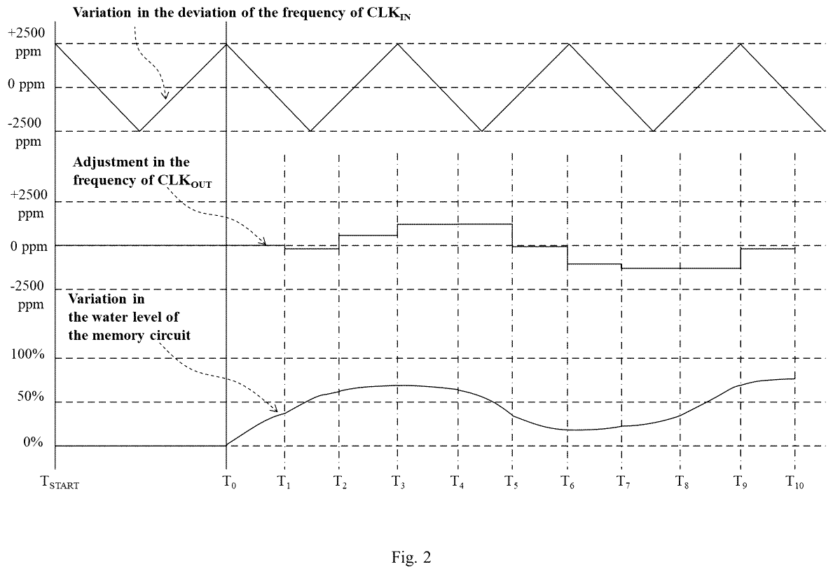

FIG. 2 shows the variation in the deviation of the frequency of the input clock CLK_{IN}, the adjustment in the frequency of the output clock CLK_{OUT}, and the variation in the water level of the memory circuit 110, wherein the unit of the variation in the deviation of the frequency of the input clock CLK_{IN} and the unit of the adjustment in the frequency of the output clock CLK_{OUT} are parts per million (ppm), and such unit (i.e., ppm) can be used to show the deviation from a specific central frequency. As shown in FIG. 2, the deviation in the frequency of the input clock CLK_{IN} varies periodically: before a time point T₀, the water level of the memory circuit 110 is zero (or alternatively, a non-zero specific water level); after the time point T₀, the water level varies with the input clock CLK_{IN} and the output clock CLK_{OUT}; after the time point T₀, the deviation in the frequency of the output clock CLK_{OUT} varies with the water-level to make the water level converge toward a predetermined water level. Generally, when the frequency of the output clock CLK_{OUT} gets higher, which implies that the data output rate of the memory circuit 110 gets higher, the water level gradually drops; and when the frequency of the output clock CLK_{OUT} gets lower, the water level gradually rises.

Referring to FIG. 2, the time points T₀˜T₁₀ jointly defines ten time intervals as follows: T₀˜T₁, T₁˜T₂, . . . , T₈˜T₉, and T₀˜T₁₀. In each time interval, the water level of the memory circuit 110 varies with time; to be more specific, the water level at the start of a time interval (e.g., T₀ of the time interval T₀˜T₁) and the water level at the end of the same time interval (e.g., T₁ of the time interval T₀˜T₁) can jointly define the variation in the water level in this time interval. The water level at the end of a time interval may represent the water level of this time interval, but the implementation of the present invention is not limited thereto.

Referring to Tables 1˜3 below, these tables show how the clock frequency regulating circuit 100 regulates the frequency of the output clock CLK_{OUT} according to the variation in the water level of the memory circuit 110 and further according to the water level of the memory circuit 110.

TABLE 1

| | Variation in water level | | | | | | | |
|---|---|---|---|---|---|---|---|---|
| | F1 | F2 | F3 | F4 | F5 | F6 | F7 | F8 |
| WL_{NOW} − | >2000 ppm | >1000 ppm | >500 ppm | >250 ppm | <250 ppm | <500 ppm | <1000 ppm | <2000 ppm |
| WL_{BEFORE} | | | | | | | | |
| (variation | | | | | | | | |
| interval) | | | | | | | | |
| DET_{FREQ} | +1000 ppm | +500 ppm | +250 ppm | +125 ppm | −125 ppm | −250 ppm | −500 ppm | −1000 ppm |

TABLE 2

| Water level | WL1 | WL2 | WL3 | WL4 |
|---|---|---|---|---|
| Ragne of | 100%~75% | 75%~50% | 50%~25% | 25%~0% |
| water level | | | | |
| (water-level | | | | |
| interval) | | | | |
| DET_{WL} | +250 ppm | +125 ppm | −125 ppm | −250 ppm |

TABLE 3

| | Time point (microsecond) | | | | | | | | | |
|---|---|---|---|---|---|---|---|---|---|---|
| | T1 | T2 | T3 | T4 | T5 | T6 | T7 | T8 | T9 | T10 |
| Water level | WL3 | WL2 | WL2 | WL2 | WL3 | WL4 | WL4 | WL3 | WL2 | WL2 |
| Variation in | zero | F3 | F4 | F5 | F6 | F5 | F4 | F4 | F3 | F4 |
| water level | | | | | | | | | | |
| Total | −125 ppm | +375 ppm | +250 ppm | 0 ppm | −375 ppm | −375 pp | −125 ppm | 0 ppm | +375 ppm | +250 ppm |
| adjustment in | | | | | | | | | | |
| frequency of | | | | | | | | | | |
| CLK_{OUT} | | | | | | | | | | |

Referring to Table 1 and FIG. 2, when the frequency detection circuit 120 determines that “the variation in the water level of the memory circuit 110 in a time interval” (e.g., the water level at the end of a time interval (hereinafter referred to as “WL_{NOW}”) minus the water level at the start of the same time interval (hereinafter referred to as “WL_{BEFORE}”); or multiplying a weighting by the result of subtracting WL_{BEFORE} from WL_{NOW}, wherein the weighting can be determined according to the last/previous frequency detection result DET_{FREQ}) is higher than a threshold (i.e., >2000 ppm, >1000 ppm, >500 ppm, or >250 ppm as shown in Table 1), the frequency detection circuit 120 generates a corresponding frequency detection result DET_{FREQ} (i.e., F1, F2, F3, or F4 as shown in Table 1) to request the CMU 140 to increase the frequency of the output clock CLK_{OUT} by a predetermined degree of adjustment (i.e., +1000 ppm, +500 ppm, +250 ppm, or +125 ppm as shown in Table 1). On the other hand, when the frequency detection circuit 120 determines that “the variation in the water level of the memory circuit 110 in a time interval” (e.g., the result of subtracting WL_{BEFORE} from WL_{NOW}; or multiplying a weighting by the result of subtracting WL_{BEFORE} from WL_{NOW}, wherein the weighting can be determined according to the last/previous frequency detection result DET_{FREQ}) is lower than a threshold (i.e., <250 ppm, <500 ppm, <1000 ppm, or <2000 ppm as shown in Table 1), the frequency detection circuit 120 generates a corresponding frequency detection result DET_{FREQ} (i.e., F5, F6, F7, or F8 as shown in Table 1) to request the CMU 140 to decrease the frequency of the output clock CLK_{OUT} by a predetermined degree of adjustment (i.e., −125 ppm, −250 ppm, −500 ppm, or −1000 ppm as shown in Table 1).

Referring to Table 1, it is noted that the aforementioned thresholds jointly define a plurality of variation intervals as follows: >2000 ppm, >1000 ppm, . . . , <1000 ppm, and <2000 ppm. The frequency detection circuit 120 can determine which of the plurality of variation intervals the variation in the water level falls within in the order of these variation intervals (e.g., an order from the first variation interval “>2000 ppm” to the last variation interval “<2000 ppm”). It is also noted that more or less variation intervals can be applied according to implementation needs; additionally, the degree of adjustment applied to each variation interval can be determined according to implementation needs.

Referring to Table 2 and FIG. 2, when the water-level detection circuit 130 determines that the water level

$$( e . g . , {WL}_{NOW} , or \frac{{WL}_{BEFORE} + {WL}_{NOW}}{2} )$$

of the memory circuit 110 in a time interval falls within a water-level interval (e.g., 100%˜75% or 75%˜50% as shown in Table 2) of a higher water level, the water-level detection circuit 130 generates a corresponding water-level detection result DET_{WL} (e.g., WL1 or WL2 as shown in Table 2) to request the CMU 140 to increase the frequency of the output clock CLK_{OUT} by a degree of adjustment (e.g., +250 ppm or +125 ppm as shown in Table 2). Similarly, when the water-level detection circuit 130 determines that the water level

$$( e . g . , {WL}_{NOW} , or \frac{{WL}_{BEFORE} + {WL}_{NOW}}{2} )$$

the memory circuit 110 in a time interval falls within a water-level interval (e.g., 50%˜25% or 25%˜0% as shown in Table 2) of a lower water level, the water-level detection circuit 130 generates a corresponding water-level detection result DET_{WL} (e.g., WL3 or WL4 as shown in Table 2) to request the CMU 140 to decrease the frequency of the output clock CLK_{OUT} by a degree of adjustment (e.g., −125 ppm or −250 ppm as shown in Table 2).

It is noted that more or less water-level intervals can be applied according to implementation needs; additionally, the degree of adjustment applied to each water-level interval can be determined according to implementation needs. It is also noted that the total number of the water-level intervals (e.g., the four water-level intervals as shown in Table 2) is less than the total number of the aforementioned variation intervals (e.g., the eight variation intervals as shown in Table 1), but the implementation of the present invention is not limited thereto.

Referring to Table 3, the CMU 140 regulates the frequency of the output clock CLK_{OUT} according to the frequency detection result DET_{FREQ} of Table 1 and the water-devel detection result DET_{WL} of Table 2. In detail:
(1) at the time point T₁: the frequency detection circuit 120 takes the last/previous water level (WL_{BEFORE}) as the water level (WL_{NOW}) at T₁ and therefore does not request the CMU 140 to regulate the frequency of the output clock CLL_{OUT} because “WL_{NOW}−WL_{BEFORE}=0”, or the frequency detection circuit 120 can request the CMU to regulate the frequency of the output clock CLK_{OUT} according to a predetermined rule (e.g., according to the degree of a difference between the water level at the time point T₁ and a predetermined water level), wherein the predetermined rule can be set according to design/implementation needs; in addition, the water-level detection circuit 130 determines that the water level at the time point T₁ falls within a water-level interval 50%˜25% and thereby generates a corresponding water-level detection result DET_{WL} (i.e., WL3 in Table 2) to request the CMU 140 to regulate the frequency of the output clock CLK_{OUT} by −125 ppm.
(2) at the time point T₂: the frequency detection circuit 120 determines that the variation in the water level is less than 1000 ppm but greater than 500 ppm and thereby generates a corresponding frequency detection result DET_{FREQ} (i.e., F3 in Table 1) to request the CMU 140 to regulate the frequency of the output clock CLL_{OUT} by +250 ppm; in the meantime, the water-level detection circuit 130 determines that the water level at the time point T₂ falls within a water-level interval 75%˜50% and thereby generates a corresponding water-level detection result DET_{WL} (i.e., WL2 in Table 2) to request the CMU 140 to regulate the frequency of the output clock CLK_{OUT} by +125 ppm; as a result, the CMU 140 regulates the frequency of the output clock CLK_{OUT} by +375 ppm (i.e., 250 ppm+125 ppm) according to the frequency detection result DET_{FREQ} and the water-level detection result DET_{WL}.
(3) the ways to regulate the frequency of the output clock CLK_{OUT} at the other time points T₃˜T₁₀ can be derived from the above description based on Tables 1˜3 and FIG. 2.

Referring to FIGS. 1˜2, in an embodiment: after the memory circuit 110 stores the data for a first period of time according to the input clock CLK_{IN}, the frequency detection circuit 120 starts detecting the variation in the storage space of the memory circuit 110, wherein the first period of time can be determined according to design/implementation needs. In an embodiment: after the memory circuit 110 stores the data for a second period of time according to the input clock CLK_{IN}, the water-level detection circuit 130 starts detecting the water level of the memory circuit 110, wherein the second period of time can be determined according to design/implementation needs. In an embodiment, the frequency detection circuit 120 and/or the water-level detection circuit 130 optionally start(s) performing the detection operation when the memory circuit 110 starts storing the data (i.e., at the time point T START as shown in FIG. 2) according to the input clock CLK_{IN}. It is noted that if the time intervals for sampling the water level (i.e., T₀˜T₁, T₁˜T₂, T₂˜T₃, and so on) are far shorter than the cycle of the input clock CLK_{IN}, the cycle of the output clock CLK_{OUT} will be equal or similar to the cycle of the input clock CLK_{IN}, but the implementation of the present invention is not limited thereto.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

To sum up, the clock frequency regulating circuit of the present disclosure can regulate the frequency of an output clock of a memory circuit according to the variation in the used amount of a storage space of the memory circuit and can be applied to a retimer or any other device in want of the function of clock frequency regulation.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A clock frequency regulating circuit, comprising:
a memory circuit configured to store data according to an input clock and output the data according to an output clock;
a frequency detection circuit coupled with the memory circuit, the frequency detection circuit configured to detect a variation in a used amount of a storage space of the memory circuit and accordingly generate a frequency detection result; and
a clock management unit (CMU) coupled with the frequency detection circuit, the CMU configured to regulate a frequency of the output clock according to the frequency detection result.

2. The clock frequency regulating circuit of claim 1, wherein after the memory circuit stores the data for a period of time according to the input clock, the frequency detection circuit starts detecting the variation in the used amount of the storage space of the memory circuit.

3. The clock frequency regulating circuit of claim 1, wherein the frequency detection circuit determines which of a plurality of variation intervals the variation falls within; when the variation falls within a first variation interval of the plurality of variation intervals, the frequency detection circuit generates the frequency detection result to request the CMU to regulate the frequency of the output clock according to a first degree of adjustment; and when the variation falls within a second variation interval of the plurality of variation intervals, the frequency detection circuit generates the frequency detection result to request the CMU to regulate the frequency of the output clock according to a second degree of adjustment.

4. The clock frequency regulating circuit of claim 3, wherein when the variation falls within the first variation interval, the frequency detection circuit generates the frequency detection result to request the CMU to increase the frequency of the output clock according to the first degree of adjustment; and when the variation falls within the second variation interval, the frequency detection circuit generates the frequency detection result to request the CMU to decrease the frequency of the output clock according to the second degree of adjustment.

5. The clock frequency regulating circuit of claim 3, wherein the first degree of adjustment is different from the second degree of adjustment.

6. The clock frequency regulating circuit of claim 3, further comprising:
a water-level detection circuit coupled to the memory circuit and the CMU, the water-level detection circuit configured to detect the used amount of the storage space of the memory circuit and thereby generate a water-level detection result,
wherein the CMU is further configured to regulate the frequency of the output clock according to the water-level detection result.

7. The clock frequency regulating circuit of claim 6, wherein after the memory circuit stores the data for a period of time according to the input clock, the water-level detection circuit starts detecting the used amount of the storage space of the memory circuit.

8. The clock frequency regulating circuit of claim 6, wherein the water-level detection circuit determines which of a plurality of water-level intervals the used amount falls within; when the used amount falls within a first water-level interval of the plurality of water-level intervals, the water-level detection circuit generates the water-level detection result to request the CMU to regulate the frequency of the output clock according to a third degree of adjustment; and when the used amount falls within a second water-level interval of the plurality of water-level intervals, the water-level detection circuit generates the water-level detection result to request the CMU to regulate the frequency of the output clock according to a fourth degree of adjustment.

9. The clock frequency regulating circuit of claim 8, wherein when the used amount falls within the first water-level interval, the water-level detection circuit generates the water-level detection result to request the CMU to increase the frequency of the output clock according to the third degree of adjustment; and when the used amount falls within the second water-level interval, the water-level detection circuit generates the water-level detection result to request the CMU to decrease the frequency of the output clock according to the fourth degree of adjustment.

10. The clock frequency regulating circuit of claim 8, wherein the third degree of adjustment is different from the fourth degree of adjustment.

11. The clock frequency regulating circuit of claim 8, wherein a total number of the plurality of water-level intervals is less than a total number of the plurality of variation intervals.

12. The clock frequency regulating circuit of claim 1, further comprising:
a water-level detection circuit coupled to the memory circuit and the CMU, the water-level detection circuit configured to detect the used amount of the storage space of the memory circuit and thereby generate a water-level detection result,
wherein the CMU is further configured to regulate the frequency of the output clock according to the water-level detection result.

13. The clock frequency regulating circuit of claim 12, wherein after the memory circuit stores the data for a period of time according to the input clock, the water-level detection circuit starts detecting the used amount of the storage space of the memory circuit.

14. The clock frequency regulating circuit of claim 12, wherein the water-level detection circuit determines which of a plurality of water-level intervals the used amount falls within; when the used amount falls within a first water-level interval of the plurality of water-level intervals, the water-level detection circuit generates the water-level detection result to request the CMU to regulate the frequency of the output clock according to a first degree of adjustment; and when the used amount falls within a second water-level interval of the plurality of water-level intervals, the water-level detection circuit generates the water-level detection result to request the CMU to regulate the frequency of the output clock according to a second degree of adjustment.

15. The clock frequency regulating circuit of claim 14, wherein when the used amount falls within the first water-level interval, the water-level detection circuit generates the water-level detection result to request the CMU to increase the frequency of the output clock according to the first degree of adjustment; and when the used amount falls within the second water-level interval, the water-level detection circuit generates the water-level detection result to request the CMU to decrease the frequency of the output clock according to the second degree of adjustment.

16. The clock frequency regulating circuit of claim 14, wherein the first degree of adjustment is different from the second degree of adjustment.

17. The clock frequency regulating circuit of claim 1, wherein the clock frequency regulating circuit is applied to a retimer.
